(19) United States
(12) Patent Application Publication
(10) Pub. No.: US 2025/0274777 A1
(43) Pub. Date: Aug. 28, 2025

(54) COMMUNICATION SYSTEM, RADIO WAVE REFRACTION PLATE, AND METHOD FOR CALCULATING INSTALLATION POSITION OF RADIO WAVE REFRACTION PLATE

(71) Applicant: KYOCERA Corporation, Kyoto-shi, Kyoto (JP)

(72) Inventors: Nobuki HIRAMATSU, Yokohama-shi, Kanagawa (JP); Daisuke TOGASHI, Yokohama-shi, Kanagawa (JP); Kengo SUGIYAMA, Fujisawa-shi, Kanagawa (JP)

(21) Appl. No.: 18/858,639

(22) PCT Filed: Apr. 14, 2023
(86) PCT No.: PCT/JP2023/015236

§ 371 Date: Oct. 21, 2024

(30) Foreign Application Priority Data
Apr. 28, 2022 (JP) 2022-075131

(51) Int. Cl. H04W 16/18; H01Q 1/24; H01Q 15/02

(52) U.S. Cl. CPC H04W 16/18; H01Q 1/246; H01Q 15/02

(57) ABSTRACT

A communication system includes a base station configured to transmit and receive a radio wave, a terminal configured to transmit and receive the radio wave to and from the base station, and a plurality of radio wave refraction plates installed on the same plane between the base station and the terminal and configured to refract the radio wave and emit a refracted radio wave in a direction of the terminal when the radio wave transmitted from the base station passes through each of the plurality of refraction plates.

### TECHNICAL FIELD

The present disclosure relates to a communication system, a radio wave refraction plate, and a method for calculating an installation position of a radio wave refraction plate.

### BACKGROUND OF INVENTION

A known technique involves controlling electromagnetic waves without using a dielectric lens. For example, Patent Document 1 describes a technique of refracting radio waves by changing parameters of respective elements in a structure including an array of resonator elements.

### CITATION LIST

### Patent Literature

Patent Document 1: JP 2015-231182 A

### SUMMARY

A communication system of the present disclosure includes: a base station configured to transmit and receive a radio wave; a terminal configured to transmit and receive the radio wave to and from the base station; and a plurality of radio wave refraction plates installed on the same plane between the base station and the terminal and configured to refract the radio wave and emit a refracted radio wave in a direction of the terminal when the radio wave transmitted from the base station passes through each of the plurality of radio wave refraction plates.

A plurality of radio wave refraction plates of the present disclosure is installed on the same plane between a base station configured to transmit and receive a radio wave and a terminal configured to transmit and receive the radio wave to and from the base station and configured to refract the radio wave and emit a refracted radio wave in a direction of the terminal when the radio wave transmitted from the base station passes through each of the plurality of radio wave refraction plates.

A method for calculating an installation position of a radio wave refraction plate includes: calculating a geometric center of center points of a plurality of radio wave refraction plates installed; setting a plane that passes through the geometric center and is orthogonal to a straight line connecting a transmission point at which a radio wave is transmitted to the plurality of radio wave refraction plates and a reception point at which the radio wave refracted by the radio wave refraction plates is received; projecting the plurality of radio wave refraction plates on the plane; and calculating installation positions of the plurality of radio wave refraction plates with an area of each of the plurality of radio wave refraction plates on the plane included in an odd-order Fresnel zone being larger than an area of each of the plurality of radio wave refraction plates on the plane included in an even-order Fresnel zone.

### BRIEF DESCRIPTION OF THE DRAWINGS

FIG. 1 illustrates a configuration example of a communication system according to an embodiment.

FIG. 2 is a diagram schematically illustrating an example of a radio wave refraction plate.

FIG. 3 is a diagram for explaining a radio wave reception method according to a comparative example of the present embodiment.

FIG. 4 is a diagram for explaining a radio wave reception method according to the present embodiment.

FIG. 5 is a diagram for explaining a radio wave reception method according to the present embodiment.

FIG. 6 is a diagram for explaining a radio wave reception method according to the present embodiment.

FIG. 7 is a diagram for explaining a radio wave refraction plate installation method according to the present embodiment.

FIG. 8 is a diagram for explaining Fresnel zones according to the present embodiment.

FIG. 9 is a flowchart illustrating a process flow for calculating an installation position of the radio wave refraction plate according to the present embodiment.

FIG. 10 is a graph for explaining angular dependence of received power according to the comparative example.

FIG. 11 is a graph for explaining angular dependence of the received power according to the embodiment.

FIG. 12 is a graph for explaining permeability properties of the radio wave refraction plates installed adjacent to each other according to the embodiment.

FIG. 13 is a graph for explaining permeability properties of the radio wave refraction plates installed adjacent to each other according to the embodiment.

### DESCRIPTION OF EMBODIMENTS

In the following, embodiments of the present disclosure will be described in detail with reference to the accompanying drawings. The present invention is not limited by the embodiments, and in the following embodiments, the same reference signs are assigned to the same portions and redundant descriptions thereof will be omitted.

In the following description, an XYZ orthogonal coordinate system is set, and the positional relationship between respective portions will be described by referring to the XYZ orthogonal coordinate system. A direction parallel to an X-axis in a horizontal plane is defined as an X-axis direction, a direction parallel to a Y-axis orthogonal to the X-axis in the horizontal plane is defined as a Y-axis direction, and a direction parallel to a Z-axis orthogonal to the horizontal plane is defined as a Z-axis direction. A plane including the X-axis and the Y-axis is appropriately referred to as an XY plane. A plane including the X-axis and the Z-axis is appropriately referred to as an XZ plane. A plane including the Y-axis and the Z-axis is appropriately referred to as a YZ plane. The XY plane is parallel to the horizontal plane. The XY plane, the XZ plane, and the YZ plane are orthogonal to each other.

### EMBODIMENT

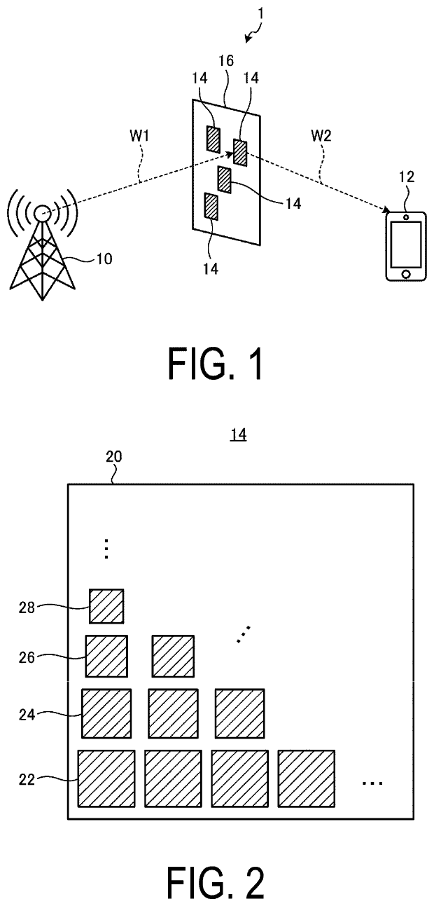

A configuration example of a communication system according to an embodiment is described with reference to FIG. 1. FIG. 1 illustrates a configuration example of a communication system according to the embodiment.

As illustrated in FIG. 1, a communication system 1 includes a base station 10, a terminal 12, and a plurality of radio wave refraction plates 14. The communication system 1 may be, for example, a communication system supporting a millimeter wave communication capable of performing large-capacity data communication in high speed, such as the fifth generation mobile communication system (hereinafter, also referred to as the “5G”) or the sixth generation mobile communication system (hereinafter, also referred to as the “6G”).

The base station 10 is a wireless communication device configured to transmit and receive radio waves to and from various external devices. For example, the base station 10 is configured to wirelessly communicate with the terminal 12 by transmitting and receiving radio waves corresponding to the 5G or 6G to and from the terminal 12. In the present embodiment, the base station 10 is configured to wirelessly communicate with the terminal 12 via the plurality of radio wave refraction plates 14 installed on the same plane.

The terminal 12 is a wireless communication device configured to transmit and receive radio waves to and from various external devices. For example, the terminal 12 is configured to wirelessly communicate with the base station 10 by transmitting and receiving radio waves corresponding to the 5G or 6G to and from the base station 10. In the present embodiment, the terminal 12 is configured to wirelessly communicate with the base station 10 via the plurality of radio wave refraction plates 14 installed on the same plane. As the terminal 12, for example, a smartphone used by a user is exemplified, but the present disclosure is not limited thereto. For example, the terminal 12 may be a relay device that relays communication between the base station 10 and a smartphone used by a user.

The radio wave refraction plates 14 are plate-shaped members configured to be permeable to the radio waves transmitted from the base station 10. For example, the radio wave refraction plates 14 are configured to refract the radio wave at a predetermined angle and emit a refracted radio wave upon receipt of the radio wave transmitted from the base station 10. Specifically, upon receipt of the radio wave transmitted from the base station 10, the radio wave refraction plates 14 are configured to refract the radio wave in a direction of the terminal 12 and emit the radio wave toward the terminal 12. The radio wave refraction plates 14 may be made of, for example, a metamaterial that changes a phase of the incident light.

FIG. 2 is a diagram schematically illustrating an example of the radio wave refraction plate 14. As illustrated in FIG. 2, the radio wave refraction plate 14 may include a substrate 20 and elements 22, 24, 26, and 28, for example.

The elements 22, the elements 24, the elements 26, and the elements 28 may be formed on the substrate 20. The substrate 20 may have a rectangular shape, for example, but is not limited thereto. The elements 22, 24, 26, and 28 may be two-dimensionally arranged on the substrate 20. Specifically, in FIG. 2, a plurality of elements 22 may be arranged in a line in the bottom row of the substrate 20. On the substrate 20, a plurality of elements 24 may be arranged in a line in a row above the row where the elements 22 are arranged. On the substrate 20, a plurality of elements 26 may be arranged in a line in a row above the row where the elements 24 are arranged. On the substrate 20, a plurality of elements 28 may be arranged in a line in a row above the row where the elements 26 are arranged. That is, the radio wave refraction plate 14 may have a structure in which a plurality of elements having different sizes is periodically arranged. The elements 22 to 28 may be different in the frequency band of the radio wave to be changed and the amount of change in the phase. The elements 22 to 28 have the rectangular shapes, without limitation. A frequency band and a phase change amount of the radio wave to be refracted can be adjusted by changing the sizes and shapes of the elements 22, 24, 26, and 28.

As illustrated in FIG. 1, the communication system 1 includes the plurality of radio wave refraction plates 14 in the present embodiment. The plurality of radio wave refraction plates 14 may be installed on the same plane 16. The example illustrated in FIG. 1 includes four radio wave refraction plates 14 installed on the plane 16, but this is merely an example and does not limit the present disclosure. The plane 16 may be a space, or a surface of a transparent structure such as a window glass. The plurality of radio wave refraction plates 14 refracts a radio wave W1 from the base station 10 and emits it as a refracted radio wave W2 to the terminal 12.

### COMPARATIVE EXAMPLE

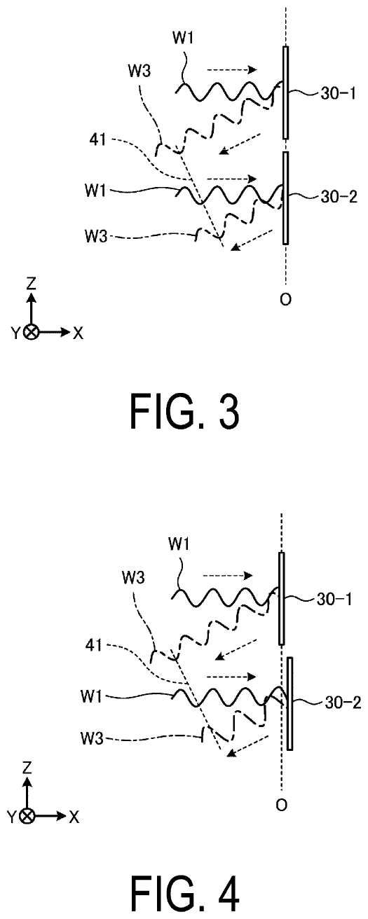

Prior to the description of the embodiment, a radio wave reception method according to a comparative example of the present embodiment is described. FIGS. 3 and 4 are diagrams for explaining a radio wave reception method according to a comparative example of the present embodiment. The comparative example illustrates a method for reflecting a radio wave from the base station 10 and receiving it by the terminal 12.

The example illustrated in FIG. 3 includes two radio wave reflective plates: a radio wave reflective plate 30-1 and a radio wave reflective plate 30-2. The radio wave reflective plate 30-1 and the radio wave reflective plate 30-2 are configured to reflect a radio wave W1 transmitted from the base station 10 at a predetermined angle as a reflected radio wave W3. In FIG. 3, the arrows assigned to the radio wave W1 and the reflected radio wave W3 indicate traveling directions of the radio wave W1 and the reflected radio wave W3, respectively. The radio wave reflective plate 30-1 and the radio wave reflective plate 30-2 are installed at an interval from each other from the origin O along the Z-axis direction so as to strengthen the phases of the reflected radio waves W3 reflected by the reflective plates 30-1 and 30-2. For example, in the example illustrated in FIG. 3, the reflected radio wave W3 reflected by the radio wave reflective plate 30-1 and the reflected radio wave W3 reflected by the radio wave reflective plate 30-2 are in the same phase at positions on a straight line 41 on the ZX plane. That is, the received power of the reflected radio wave W3 reflected by the radio wave reflective plate 30-1 and the received power of the reflected radio wave W3 reflected by the radio wave reflective plate 30-2 strengthen each other at positions on the straight line 41 on the ZX plane.

FIG. 4 illustrates an example in which the radio wave reflective plate 30-2 is shifted by λ/4 from the origin O to the positive direction side of the X-axis, where A is the wavelength of the radio wave W1. For example, λ/4 is 2.7 millimeters (mm) when 2 is 28 gigahertz (GHz). In this case, as illustrated in FIG. 4, the reflected radio wave W3 reflected by the radio wave reflective plate 30-1 and the reflected radio wave W3 reflected by the radio wave reflective plate 30-2 are in opposite phases at positions on the straight line 41 on the ZX plane. That is, the received power of the reflected radio wave W3 reflected by the radio wave reflective plate 30-1 and the received power of the reflected radio wave W3 reflected by the radio wave reflective plate 30-2 weaken each other at positions on the straight line 41 on the ZX plane. Thus, even when the plurality of radio wave reflective plates is used to increase the area of the reflective plates, the reflected radio waves do not necessarily strengthen each other, and the received power may not be enhanced.

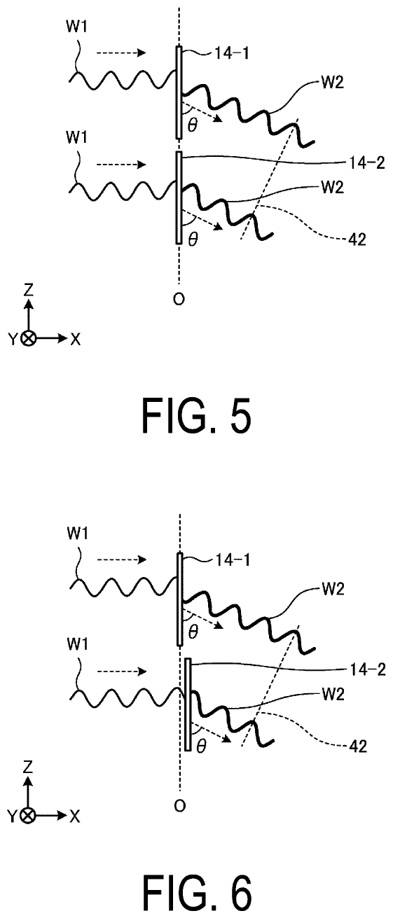

A radio wave receiving method according to the present embodiment is described. FIGS. 5 and 6 are diagrams for explaining the radio wave reception method according to the present embodiment.

The example illustrated in FIG. 5 includes two refraction plates: a radio wave refraction plate 14-1 and a radio wave refraction plate 14-2. The radio wave refraction plate 14-1 and the radio wave refraction plate 14-2 are configured to reflect the radio wave W1 transmitted from the base station 10 at a predetermined angle θ as the refracted radio wave W2. In FIG. 5, arrows assigned to the radio wave W1 and the refracted radio wave W2 indicate the traveling directions of the radio wave W1 and the refracted radio wave W2, respectively. The radio wave refraction plate 14-1 and the radio wave refraction plate 14-2 are installed at an interval from each other along the Z-axis direction from the origin O so as to strengthen the phases of the radio waves W2 refracted, respectively. For example, in the example illustrated in FIG. 5, at positions on the straight line 42 on the ZX plane, the refracted radio wave W2 refracted by the radio wave refraction plate 14-1 and the refracted radio wave W2 refracted by the radio wave refraction plate 14-2 are in the same phase. That is, the received power of the refracted radio wave W2 refracted by the radio wave refraction plate 14-1 and the received power of the refracted radio wave W2 refracted by the radio wave refraction plate 14-2 strengthen each other at positions on the straight line 32 on the ZX plane.

FIG. 6 illustrates an example in which the radio wave refraction plate 14-2 is shifted by λ/4 from the origin O to the positive direction side of the X-axis, where A is the wavelength of the radio wave W1. In the present embodiment, as illustrated in FIG. 6, even when the radio wave refraction plate 14-2 is shifted to the positive direction side of the X-axis, the path length does not substantially change. Therefore, in the present embodiment, even when the radio wave refraction plate 14-2 is displaced to the positive direction side of the X-axis, the refracted radio wave W2 refracted by the radio wave refraction plate 14-1 and the refracted radio wave W2 refracted by the radio wave refraction plate 14-2 are in the same phase at positions on the straight line 32 on the ZX plane. That is, in the present embodiment, since the received power is not weakened, the received power can be increased by increasing the areas of the reflective plates using the plurality of radio wave reflective plates.

In the present embodiment, the interval between the radio wave refraction plates 14-1 and 14-2 is s, the refraction angle of the refracted radio wave W2 is θ, and the deviation between the radio wave refraction plate 14-1 and the radio wave refraction plate 14-2 in the thickness direction (the X-axis direction in FIG. 6) is preferably s/tan θ or less. Making the deviation in the thickness direction (the X-axis direction in FIG. 5) of the radio wave refraction plate 14-1 and the radio wave refraction plate 14-2 s/tan θ or less can increase the received power.

### Radio Wave Refraction Plate Installation Method

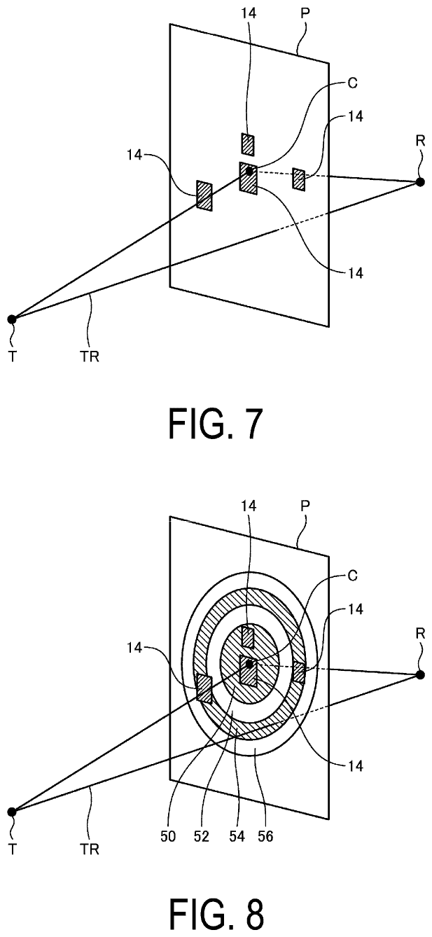

A radio wave refraction plate installation method according to the present embodiment is described. FIG. 7 is a diagram for explaining the installation method of the radio wave refraction plates according to the present embodiment.

In the present embodiment, the path of the radio wave from the transmission point T to the reception point R passing through a point on the radio wave refraction plate 14 is considered, and the radio wave refraction plate 14 is installed with the area installed in an area where the radio waves strengthen each other being larger than the area installed in an area where the radio waves weaken each other. Thus, the present embodiment can obtain higher received power. In the present embodiment, a region in which radio waves strengthen each other is referred to as an odd-order Fresnel zone, and a region in which radio waves weaken each other is referred to as an even-order Fresnel zone.

### Fresnel Zone

A definition of a Fresnel zone according to the present embodiment is described. As illustrated in FIG. 7, a situation in which a radio wave from the transmission point T passes through the plurality of radio wave refraction plates 14 and reaches the reception point R is considered. The transmission point T indicates the position of an antenna of the base station 10, and the reception point R indicates the position of an antenna of the terminal 12. In FIG. 7, a geometric center (gravity center) of the center points of the plurality of radio wave refraction plates 14 is defined as a geometric center C. Let d₁ be a linear distance between the transmission point T and the geometric center C. Let d₂ be a distance between the reception point R and the geometric center C. A plane P that passes through the geometric center C and is orthogonal to a straight line TR connecting the transmission point T and the reception point R is considered. Here, on the plane P, a circle centered at the geometric center C and having a radius defined by Equation (1) is considered.

$$[ Math 1 ]$$

$${R}_{n} = \sqrt{\frac{n λ {d}_{1} {d}_{2}}{{d}_{1} + {d}_{2}}} \qquad ( 1 )$$

In Equation (1), n is a natural number, and λ is a wavelength of the radio wave.

FIG. 8 is a diagram for explaining Fresnel zones according to the present embodiment. In the present embodiment, in Equation (1), an annular portion in a range from a radius Rₙ₋₁ to a radius Rₙ is defined as an n-th Fresnel zone. The example illustrated in FIG. 8 includes a first Fresnel zone 50, a second Fresnel zone 52, a third Fresnel zone 54, and a fourth Fresnel zone 56.

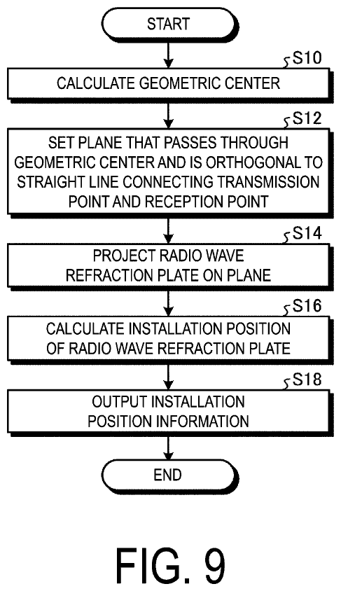

A method for calculating an installation position of a radio wave refraction plate according to the present embodiment is described with reference to FIGS. 8 and 9. FIG. 9 is a flowchart illustrating a process flow for calculating an installation position of the radio wave refraction plate according to the present embodiment.

The processing illustrated in FIG. 9 is processing executed by an information processing device such as a personal computer (not illustrated).

The information processing device calculates the geometric center C of the center points of the plurality of installed radio wave refraction plates 14 (step S10). Subsequently, the process proceeds to step S12.

The information processing device sets the plane P that passes through the geometric center C and is orthogonal to the straight line TR connecting the transmission point T and the reception point R (step S12). Subsequently, the process proceeds to step S14.

The information processing device projects the plurality of radio wave refraction plates 14 on the plane P (step S14). Subsequently, the process proceeds to step S16.

The information processing device calculates the installation positions of the plurality of radio wave refraction plates 14 (step S16). Specifically, the information processing device calculates the installation positions of the plurality of radio wave refraction plates 14 such that the areas of the radio wave refraction plates 14 included in the odd-order Fresnel zone are larger than the areas of the radio wave refraction plates 14 included in the even-order Fresnel zone. More specifically, in the example illustrated in FIG. 7, the installation positions of the plurality of radio wave refraction plates 14 are calculated such that the areas of the radio wave refraction plates 14 included in the first Fresnel zone 50 and the third Fresnel zone 54 are larger than the areas of the radio wave refraction plates 14 included in the second Fresnel zone 52 and the fourth Fresnel zone 56. Subsequently, the process proceeds to step S18.

The information processing device outputs installation position information on the installation positions of the plurality of radio wave refraction plates 14 (step S18). Accordingly, the user can adjust the installation positions of the plurality of radio wave refraction plates 14 based on the installation position information.

### Distance Setting Method

A method for setting a distance between the terminal 12 and the plurality of radio wave refraction plates 14 according to the present embodiment is described.

When the distance from the radio wave refraction plate 14 is sufficiently shorter than the long side of the radio wave refraction plate 14 (near region), a wide beam width of the refracted radio wave from the radio wave refraction plate 14 is obtained and the power is dispersed, making it difficult to obtain high received power. A linear distance between the reception point R and the geometric center C of the center points of the plurality of radio wave refraction plates 14 is d₂, the sum of maximum dimensions (e.g., diagonal lines) of the plurality of installed radio wave refraction plates 14 is Lₛᵤₘ, and d₂ preferably satisfies the following Expression (2).

$$[ Math 2 ]$$

$${d}_{2} > 0.62 \sqrt{\frac{{L}_{sum}^{3}}{λ}} \qquad ( 2 )$$

When the linear distance d₂ satisfies Expression (2), the beam width of the refracted radio wave is narrow, thus allowing a higher received power to be obtained as compared with the case in which only one radio wave refraction plate 14 is installed.

### Angular Dependence of Received Power

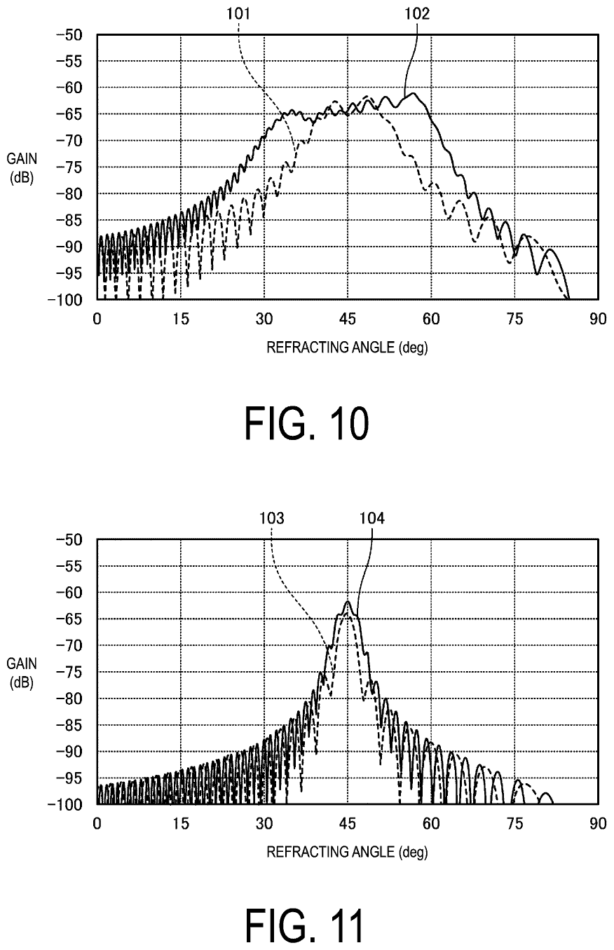

Angular dependence of the received power is described with reference to FIGS. 10 and 11. FIG. 10 is a graph for explaining the angular dependence of the received power according to the comparative example. FIG. 11 is a graph for explaining the angular dependence of the received power according to the embodiment.

FIG. 10 shows the angular dependence of the received power when the above Expression (2) is not satisfied. Specifically, FIG. 10 shows the angular dependence when the d₂ is 0.75 m, Lₛᵤₘ is 0.6 m, and λ is 28 GHz.

FIG. 10 shows a waveform 101 and a waveform 102. In FIG. 10, the horizontal axis represents the refraction angle [deg (degree)] and the vertical axis represents the gain [dB]. The waveform 101 indicates the angular dependence of the received power when one radio wave refraction plate 14 is installed. The waveform 102 indicates the angular dependence of the received power when two radio wave refraction plates 14 are installed. As indicated by the waveform 101 and the waveform 102, the power distribution of the refracted radio waves is widened by installing two radio wave refraction plates 14.

FIG. 11 shows the angular dependence of the received power when the above Expression (2) is satisfied. Specifically, FIG. 11 shows the angular dependence of received power when d₂ is 5.0 m, Lₛᵤₘ is 0.6 m, and λ is 28 GHz.

FIG. 11 shows a waveform 103 and a waveform 104. In FIG. 11, the horizontal axis represents the refraction angle [deg] and the vertical axis represents the gain [dB]. The waveform 103 indicates the angular dependence of the received power when one radio wave refraction plate 14 is installed. The waveform 104 indicates the angular dependence of received power when two radio wave refraction plates 14 are installed. As indicated by the waveform 103 and the waveform 104, the gain of the received power increases and the power distribution is narrowed by installing two radio wave refraction plates 14.

That is, as shown in FIGS. 10 and 11, when d₂ satisfies the above Expression (2), a higher received power can be obtained by installing a plurality of radio wave refraction plates 14.

### Relative Relationship

A preferred method for installing the radio wave refraction plates 14 in installing the plurality of radio wave refraction plates 14 adjacent to other radio wave refraction plates 14 is described.

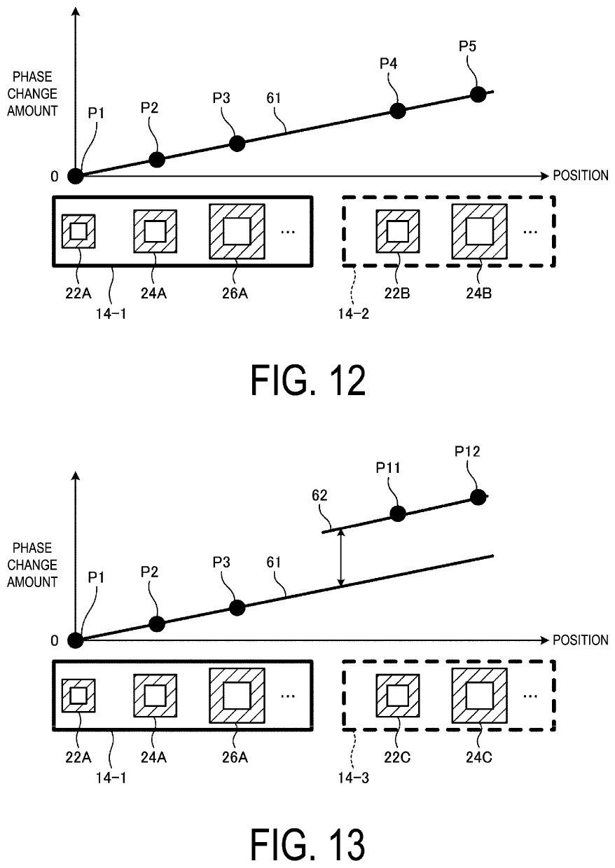

FIGS. 12 and 13 are graphs for explaining permeability properties of the radio wave refraction plates installed adjacent to each other according to the embodiment.

In FIG. 12, the radio wave refraction plate 14-1 and the radio wave refraction plate 14-2 are installed with the area included in the odd-order Fresnel zone being larger than the area included in the even-order Fresnel zone and are installed adjacent to each other. The radio wave refraction plate 14-1 and the radio wave refraction plate 14-2 may be installed in the same odd-order Fresnel zone or may be installed in different odd-order Fresnel zones.

The radio wave refraction plate 14-1 includes elements 22A, 24A, and 26A. The radio wave refraction plate 14-2 includes elements 22B and 24B. In the example shown in FIG. 12, the elements 22A, 24A, 26A, and the like are installed adjacent to the elements 22B, 24B, and the like.

In the graph of FIG. 12, the horizontal axis represents the installation position of the radio wave refraction plates 14, and the vertical axis represents the phase change amount [degree]. A point P1 indicates the installation position and the phase change amount of the element 22A. A point P2 indicates the installation position and the phase change amount of the element 24A. A point P3 indicates the installation position and the phase change amount of the element 26A. A point P4 indicates the installation position and the phase change amount of the element 22B. A point P5 indicates the installation position and the phase change amount of the element 24B.

As shown in FIG. 12, the radio wave refraction plate 14-1 and the radio wave refraction plate 14-2 are installed so that the points P1 to P5 are on a straight line 61 in the present embodiment. Accordingly, the radio wave refraction plate 14-1 and the radio wave refraction plate 14-2 can increase the received power of the refracted radio wave and can further improve the properties.

In the example shown in FIG. 13, the radio wave refraction plate 14-1 is installed so that the area included in the odd-order Fresnel zone is larger than the area included in the even-order Fresnel zone. The radio wave refraction plate 14-3 is installed so that the area included in the even-order Fresnel zone is larger than the area included in the odd-order Fresnel zone. The radio wave refraction plate 14-1 and the radio wave refraction plate 14-3 are installed adjacent to each other.

In the graph of FIG. 13, the horizontal axis represents the installation positions of the radio wave refraction plates 14, and the vertical axis represents the phase change amount [degree]. A point P1 indicates the installation position and the phase change amount of the element 22A. A point P2 indicates the installation position and the phase change amount of the element 24A. A point P3 indicates the installation position and the phase change amount of the element 26A. A point P11 indicates the installation position and the phase change amount of the element 22C. A point P12 indicates the installation position and the phase change amount of the element 24C.

As shown in FIG. 13, the radio wave refraction plate 14-1 is installed so that the points P1 to P3 are on the straight line 61, while the radio wave refraction plate 14-3 is installed so that the points P11 and P12 are off the straight line 61 in the present embodiment. That is, the radio wave refraction plate whose area included in the even-order Fresnel zone is larger than the area included in the odd-order Fresnel zone is installed off the straight line 61.

In the example shown in FIG. 13, the radio wave refraction plate 14-3 is installed such that the points P11 and P12 are on a straight line 62. That is, the radio wave refraction plate 14-3 is installed so that the phase change amount is shifted from that of the radio wave refraction plate 14-1. Since the even-order Fresnel zone is a region in which radio waves weaken each other, installing the radio wave refraction plate 14-3 off the straight line 61 can increase the received power of the refracted radio waves and further improve the properties.

The arrow between the straight line 61 and the straight line 62 indicates a deviation of the phase change amount between the straight line 61 and the straight line 62. Making the deviation of the phase change amount between the straight line 61 and the straight line 62, for example, 180 degrees, can further improve the properties. The deviation of the phase change amount between the straight line 61 and the straight line 62 is not limited to 180 degrees.

An embodiment of the present disclosure has been described above, but the present disclosure is not limited by the contents of the embodiment. Constituent elements described above include those that can be easily assumed by a person skilled in the art, those that are substantially identical to the constituent elements, and those within a so-called range of equivalency. The constituent elements described above can be combined as appropriate.

Various omissions, substitutions, or modifications of the constituent elements can be made without departing from the spirit of the above-described embodiment.

### REFERENCE SIGNS

1 Communication system
10 Base station
12 Terminal
14 Radio wave refraction plate
16 Plane
20 Substrate
22, 24, 26, 28 Element
30-1, 30-2 Radio wave reflective plate
50 First Fresnel zone
52 Second Fresnel zone
54 Third Fresnel zone
56 Fourth Fresnel zone

1. A communication system, comprising:
a base station configured to transmit and receive a radio wave;
a terminal configured to transmit and receive the radio wave to and from the base station; and
a plurality of radio wave refraction plates installed on the same plane between the base station and the terminal and configured to refract the radio wave and emit a refracted radio wave in a direction of the terminal when the radio wave transmitted from the base station passes through each of the plurality of radio wave refraction plates.

2. The communication system according to claim 1,
wherein each of the plurality of radio wave refraction plates is installed, on an installation plane that passes through a geometric center of the plurality of radio wave refraction plates and is orthogonal to a line connecting an antenna of the base station and an antenna of the terminal, in a region defined by a first linear distance between the antenna of the base station and a geometric center of each of the plurality of radio wave refraction plates and a second linear distance between the antenna of the terminal and the geometric center of each of the plurality of radio wave refraction plates.

3. The communication system according to claim 2,
wherein the first linear distance is d₁,
the second linear distance is d₂,
on the plane, a circle centered at a geometric center C and having a radius defined by Equation (1) below is considered,
$$[ Math 1 ]$$
$${R}_{n} = \sqrt{\frac{n λ {d}_{1} {d}_{2}}{{d}_{1} + {d}_{2}}} \qquad ( 1 )$$
in Equation (1), n is a natural number, and λ is a wavelength of a radio wave,
an annular portion in a range from a radius Rₙ₋₁ to a radius Rₙ is defined as an n-th Fresnel zone, and
the radio wave refraction plates are installed with an area of each of the plurality of radio wave refraction plates included in an odd-order Fresnel zone being larger than an area of each of the plurality of radio wave refraction plates included in an even-order Fresnel zone.

4. The communication system according to claim 2,
wherein the region defined based on the first linear distance and the second linear distance comprises an odd-order Fresnel zone and an even-order Fresnel zone,
an area of each of the plurality of radio wave refraction plates projected on the installation plane is considered, and
each of the plurality of radio wave refraction plates is installed with an area included in the odd-order Fresnel zone being larger than an area included in the even-order Fresnel zone.

5. The communication system according to claim 1,
wherein an interval between adjacent ones of the plurality of radio wave refraction plates is s,
a refraction angle of the radio wave is θ, and
a deviation between the adjacent ones of the plurality of radio wave refraction plates in a thickness direction is equal to or less than s/tan θ.

6. The communication system according to claim 1,
wherein a sum of maximum dimensions of the plurality of radio wave refraction plates is Lₛᵤₘ,
a wavelength of the radio wave is λ, and
a distance between the antenna of the terminal and the geometric center of each of the plurality of radio wave refraction plates is
$${d}_{2} > 0.62 \sqrt{\frac{{L}_{sum}^{3}}{λ}} .$$

7. The communication system according to claim 1,
wherein coordinates of a plurality of unit structures included in the plurality of radio wave refraction plates are plotted on a graph indicating a position on a horizontal axis and a transmission phase on a vertical axis, and
the plurality of radio wave refraction plates is installed with the coordinates placed on a straight line.

8. The communication system according to claim 4,
wherein coordinates of a plurality of unit structures included in the plurality of radio wave refraction plates are plotted on a graph indicating a position on a horizontal axis and a transmission phase on a vertical axis,
the plurality of radio wave refraction plates is installed with, of the plurality of radio wave refraction plates, a radio wave refraction plate having an area included in the odd-order Fresnel zone larger than an area included in the even-order Fresnel zone being placed on a straight line and a radio wave refraction plate having an area included in the even-order Fresnel zone larger than an area included in the odd-order Fresnel zone being placed off the straight line.

9. The communication system according to claim 8,
wherein the radio wave refraction plate having the area included in the even-order Fresnel zone larger than the area included in the odd-order Fresnel zone is installed with a phase change amount being shifted by 180 degrees from the straight line.

10. A radio wave refraction plate, comprising
a plurality of radio wave refraction plates installed on the same plane between a base station configured to transmit and receive a radio wave and a terminal configured to transmit and receive the radio wave to and from the base station and configured to refract the radio wave and emit a refracted radio wave in a direction of the terminal when the radio wave transmitted from the base station passes through each of the plurality of radio wave refraction plates.

11. The radio wave refraction plate according to claim 10,
wherein each of the plurality of radio wave refraction plates is installed, on an installation plane that passes through a geometric center of the plurality of radio wave refraction plates and is orthogonal to a line connecting an antenna of the base station and an antenna of the terminal, in a region defined by a first linear distance between the antenna of the base station and a geometric center of each of the plurality of radio wave refraction plates and a second linear distance between the antenna of the terminal and the geometric center of each of the plurality of radio wave refraction plates.

12. The radio wave refraction plate according to claim 11,
wherein the first linear distance is d₁,
the second linear distance is d₂,
on the plane, a circle centered at a geometric center C and a radius defined by Equation (1) below is considered,
$$[ Math 2 ]$$
$${R}_{n} = \sqrt{\frac{n λ {d}_{1} {d}_{2}}{{d}_{1} + {d}_{2}}} \qquad ( 1 )$$
in Equation (1), n is a natural number, and λ is a wavelength of a radio wave,
an annular portion in a range from a radius Rₙ₋₁ to a radius Rₙ is defined as an n-th Fresnel zone, and
the radio wave refraction plates are installed with an area of each of the plurality of radio wave refraction plates included in an odd-order Fresnel zone being larger than an area of each of the plurality of radio wave refraction plates included in an even-order Fresnel zone.

13. The radio wave refraction plate according to claim 11,
wherein the region defined based on the first linear distance and the second linear distance comprises an odd-order Fresnel zone and an even-order Fresnel zone,
an area of each of the plurality of radio wave refraction plates projected on the installation plane is considered, and
each of the plurality of radio wave refraction plates is installed with an area included in the odd-order Fresnel zone being larger than an area included in the even-order Fresnel zone.

14. The radio wave refraction plate according to claim 10,
wherein an interval between adjacent ones of the plurality of radio wave refraction plates is s,
a refraction angle of the radio wave is θ, and
a deviation between the adjacent ones of the plurality of radio wave refraction plates in a thickness direction is equal to or less than s/tan θ.

15. The radio wave refraction plate according to claim 10,
wherein a sum of maximum dimensions of the plurality of radio wave refraction plates is Lₛᵤₘ,
a wavelength of the radio wave is λ, and
a distance between the antenna of the terminal and the geometric center of each of the plurality of radio wave refraction plates is 0.62×(Lₛᵤₘ³/λ) or greater.

16. The radio wave refraction plate according to claim 10,
wherein coordinates of a plurality of unit structures included in the plurality of radio wave refraction plates are plotted on a graph indicating a position on a horizontal axis and a transmission phase on a vertical axis, and
the plurality of radio wave refraction plates is installed with the coordinates placed on a straight line.

17. The radio wave refraction plate according to claim 13,
wherein coordinates of a plurality of unit structures included in the plurality of radio wave refraction plates are plotted on a graph indicating a position on a horizontal axis and a transmission phase on a vertical axis,
the plurality of radio wave refraction plates is installed with, of the plurality of radio wave refraction plates, a radio wave refraction plate having an area included in the odd-order Fresnel zone larger than an area included in the even-order Fresnel zone being placed on a straight line and a radio wave refraction plate having an area included in the even-order Fresnel zone larger than an area included in the odd-order Fresnel zone being placed off the straight line.

18. The radio wave refraction plate according to claim 17,
wherein the radio wave refraction plate having the area included in the even-order Fresnel zone larger than the area within the odd-order Fresnel zone is installed with a phase change amount being shifted by 180 degrees from the straight line.

19. A method for calculating an installation position of a radio wave refraction plate, the method comprising:
calculating a geometric center of center points of a plurality of radio wave refraction plates installed;
setting a plane that passes through the geometric center and is orthogonal to a straight line connecting a transmission point at which a radio wave is transmitted to the plurality of radio wave refraction plates and a reception point at which the radio wave refracted by the radio wave refraction plates is received;
projecting the plurality of refraction plates on the plane; and
calculating installation positions of the plurality of radio wave refraction plates with an area of each of the plurality of radio wave refraction plates included in an odd-order Fresnel zone being larger than an area of each of the plurality of radio wave refraction plates included in an even-order Fresnel zone.
